(19) United States
(12) Patent Application Publication
(10) Pub. No.: US 2014/0137122 A1
(43) Pub. Date: May 15, 2014

(54) MODIFIED BACKFILL SCHEDULER AND A METHOD EMPLOYING FREQUENCY CONTROL TO REDUCE PEAK CLUSTER POWER REQUIREMENTS

(71) Applicants: David A. Egolf, Glendale, AZ (US); Russell W. Guenthner, Glendale, AZ (US)

(72) Inventors: David A. Egolf, Glendale, AZ (US); Russell W. Guenthner, Glendale, AZ (US)

(21) Appl. No.: 13/675,219

(22) Filed: Nov. 13, 2012

(51) Int. Cl. G06F 9/46

(52) U.S. Cl. 718/102; 713/320

(57) ABSTRACT

A method is disclosed for reducing peak power usage in a large computer system with multiple nodes by identifying jobs which can be scheduled to run at reduced frequency in order to reduce total power usage during certain time periods. The backfill scheduler of the computer system's operating system performs steps providing for selected jobs on selected nodes of the computer system to be run at reduced frequency such that those jobs are partially processed during previously underutilized holes in the computer system schedule in order to reduce overall peak power during a period of processing.

### CROSS REFERENCE TO RELATED APPLICATIONS

Reference to U.S. Provisional Patent Application 61/560,652 filed Nov. 16, 2011

This application claims priority to a U.S. Provisional Patent Application 61/560,652 Filed Nov. 16, 2011 titled “A MODIFIED BACKFILL SCHEDULER AND A METHOD EMPLOYING FREQUENCY CONTROL TO REDUCE PEAK CLUSTER POWER REQUIREMENTS” with first named inventor David A. Egolf, Glendale, Ariz. (US), which is expressly incorporated herein as though set forth in full.

### STATEMENT REGARDING FEDERALLY SPONSORED RESEARCH OR DEVELOPMENT

None

### THE NAMES OF PARTIES TO A JOINT RESEARCH AGREEMENT

None

### INCORPORATION-BY-REFERENCE OF MATERIAL SUBMITTED ON A COMPACT DISC

None

### BACKGROUND OF THE INVENTION

Recently developed processor chip sets for the ubiquitous Intel processors are exposing more power reporting and control interfaces with almost every release. The Basic Input Output System (BIOS) and operating systems of today's computer systems that are required for making use of these interfaces are trying to keep pace. In today's systems, being able to collect data on power consumption over a given period is more common by node rather than by processor or even by socket. With the advent of nodes with up to hundreds of processors it has become common practice to share nodes between scheduled jobs.

The BIOS and Power reporting features development provides for the collection of power consumption data such that power consumption data for specific jobs can be reported to the end users and the site managers or programmers for further evaluation. Because of limited API's (Application Program Interfaces) and node sharing this data may not be precise, but is still useful.

There are alternatives in the prior art for managing power consumption whether for a single processor, for a single socket, for a plurality of boards or modules, or within a computer “node”. For example, some current processors, comprising one or more cores, may be configured to manage their own temperature profiles and power consumption. This is done by having the processor chip or module manage its own power by manipulating its own frequency and or voltage levels. However, this approach may not be desirable for use in large systems such as High Performance Cluster (HPC) systems that are executing applications distributed across thousands of nodes because the nodes may then be potentially running at different speeds which may hinder communication or possibly greatly slow overall system performance.

As known in the art, the term “computer cluster”, referred to as “cluster” for short, is a type of computer system which completes computing jobs by means of multiple collaborative computers (also known as computing resources such as software and/or hardware resources) which are connected together. These computing resources in a same management domain have a unified management policy and provide services to users as a whole. A single computer in a cluster system is usually called a node or a computing node. The term “node” is meant to be interpreted in a general way. That is, a node can be one processor in a single cabinet, one board of processors in a single cabinet, or several boards in a single cabinet. A node can also be a virtualized collection of computing resources where physical boundaries of the hardware resources are less important.

Also, as known in the art, the scheduling of a plurality of jobs for running by a computer system, or cluster system is typically done by an operating system program module called a scheduler. Schedulers typically accept jobs from users (or from the system itself) and then schedule those jobs so as to complete them efficiently using the available or assigned system resources. Two exemplary methods of scheduling or scheduling policies are “FIFO” meaning First In First Out, and “Priority” meaning jobs are prioritized in some manner and that more important jobs are scheduled so they are more likely to run sooner than jobs having lower priority. Scheduling algorithms or policies may be quite inexact in that for example, a lower priority job may run before a higher priority depending on specific methods of scheduling or policy enforced or incorporated by a specific scheduler, or also depending on specific resource requirements.

“Backfill” scheduling is a method of scheduling or policy that typically fits on top of or follows a FIFO or Priority scheduler, for example, and attempts to fill in voids or holes in a proposed schedule and more efficiently use resources. This may result in the time required to execute a plurality of jobs being reduced from that which would be achieved for example, by a FIFO or Priority scheduler alone. Here, the term “backfill” as used herein is a form of scheduling optimization which allows a scheduler to make better use of available resources by running jobs out of order. An advantage of such scheduling is that the total system utilization is increased since more jobs may be run in a given interval of time.

In general, a backfill scheduler schedules jobs in an order that is out of order with the arrival of those jobs. That is, for example, if jobs arrive in order 1, 2, 3 a backfill scheduler is allowed to schedule those jobs for starting in an order that is different than 1, 2, 3. A strict FIFO scheduler does not typically schedule jobs out of order. In similar manner if jobs are ordered in priority 1, 2, 3 a backfill scheduler may move the starting times of selected jobs so that some of the jobs are started in an order that is out of the order of priority. A strict Priority based scheduler does not typically schedule jobs out of order of priority.

Various optimized scheduling policies for handling various types of jobs are found in the prior art. For example, there are scheduling policies for real time jobs, parallel jobs, serial jobs, and transaction type jobs. Typically, a first in first out (FIFO) scheduling policy is based on looking at priorities of jobs in queues and is beneficial for scheduling serial jobs. A backfill scheduling policy is typically used and is beneficial for handling large-scale parallel jobs as might typically be processed by a Cluster system with dozens, hundreds or even thousands of processing nodes.

Brief descriptions of two typical backfill schedulers from the prior art are provided in Appendices A, and B and such descriptions clearly establish the basis of the methods implemented within a computer system scheduler that are being proposed for modification according to certain illustrated embodiments of the present invention as described hereafter.

### BRIEF SUMMARY OF THE INVENTION

In an illustrated embodiment of the present invention, the method or steps performed by a backfill scheduler are modified so as to improve the management of power, and more specifically “peak” power during the running of a plurality of jobs.

It is very beneficial in management of peak power of HPC systems to provide power control features that allow either site management or user software to explicitly set CPU speed parameters, instead of the CPU making those decisions itself. This may potentially help in guaranteeing uniformity over time in either average or maximum peak power usage between the nodes and processors running specific jobs.

Some operating systems and/or BIOS control programs may also allow either the scheduler or the running jobs themselves to manipulate either the system frequency or the frequency of a node. It may also be allowed or provided for applications themselves to explicitly set, change or modify the processor frequency multiple times during the course of a job or series of jobs.

In an illustrated embodiment of the present invention, a “backfill scheduler” is modified to consider or examine, in its processing, the voids in a normal First In/First Out (FIFO), or Priority or other scheduler which are not normally filled by lower priority jobs. The scheduler determines if these voids can be filled by reducing the CPU frequency of the preceding jobs by an amount that will still allow them to complete before the next scheduling event or job which follows the void. This scheduler mechanism allows these preceding jobs to employ lower peak power usage during their time of execution. This approach or methodology may potentially provide for reducing power during certain periods of time for thousands of nodes, and thus has potential for significantly lowering the peak power requirements of an entire site or an entire cluster. Also, this approach can be optionally implemented by a method that does not delay the start time of any scheduled job, which can be viewed as an advantage.

For purpose of illustration before discussing specifics, it is important for understanding examples presented herein to have a description of the starting point for a typical program (job) scheduler which is described as First In First Out (FIFO). In the examples, the FIFO is viewed as being an algorithm for scheduling a job that “looks at” (examines the predicted attributes) of only one job at a time. That is, as jobs arrive at the input of the FIFO scheduler, the FIFO scheduler looks at the present schedule, and without changing the assignment of previous jobs, makes an assignment of the job presented for scheduling. In the following examples, the FIFO operates such that the job currently being scheduled will not be scheduled any earlier (prior in time) to any other previously scheduled job. The FIFO scheduler IS allowed to start the job currently being scheduled at the SAME time as prior jobs.

A “backfill” scheduler is an enhancement to the FIFO example just described which provides for the scheduler to look “back” and place jobs into the schedule at an assigned time that might be before a job already scheduled. For example, Job 5 might be scheduled to start before Job 6 even though Job 5 arrived for scheduling first. This approach potentially allows for more dense scheduling of resources (more highly utilized) than the pure FIFO approach, but is more complicated, and also may seem unfair to users because a later scheduled job might get done before an earlier scheduled job.

In another illustrated embodiment of the present invention, the goal is not to delay the finish time of any scheduled job.

In still another illustrated embodiment of the present invention, another goal is to complete all jobs within the same time as would have been achieved with a normal FIFO scheduling algorithm. In another illustrated embodiment of the present invention, a further goal is to complete all jobs before some specific time, over some specific period of time, or within various constraints in time that might be described by one well versed in the art of computer scheduling, and computer scheduler design.

As known in the art, Large High Performance Computer clusters may consist of thousands of compute nodes each with up to several hundred CPU cores (a core is a single processing unit). Clusters often consume large amounts of power. Feeding power to the cluster and getting rid of the heat produced is a major issue for its operation, and operation of, and control of expenses related to running a cluster or an entire computer site. There may be tens or even thousands of jobs executing and being scheduled on the cluster of nodes. Typically, the jobs are comprised of programs which run on each of the nodes allocated for the job run.

Some priority scheme is typically employed in order to choose an order or schedule to be used to run the jobs. The software which chooses the job is referred to as the cluster job scheduler. It is typical for all the nodes or other resources required for a particular job to not be available at the time of job submission. Thus, jobs must wait until their node and other resource requirements are met. While they are waiting, it is possible that many of the nodes that they will eventually use become free. The nodes which became free may sit idle unless the cluster job scheduler can find something for them to do.

A normal backfill scheduler will search for lower priority jobs which could successfully use these smaller number of nodes and still complete in time for the scheduled start of the aforementioned job which is waiting for all the nodes to become free. This requires that the expected runtime of these “backfill” jobs be known to the scheduler. It is typical for the runtime of submitted jobs to be included as an estimate in the job submission in order to facilitate this type of scheduling.

The method of the present invention takes advantage of the fact that there may not be any suitable jobs which can be employed to fill a void. The scheduler is capable of seeing or detecting these unusable voids as soon as the next job to run is in the queue. At that time, according to an illustrated embodiment of the present invention, the scheduler operates to attempt to reduce the size of voids by decreasing the CPU frequency of the nodes running specific jobs which will become idle prior, or which are scheduled to complete prior to the next job start. This decrease in the frequency elongates (extends) the execution time of these jobs and reduces the peak power required during this period.

A person knowledgeable in the art will be able to employ the techniques of the present invention for either a CPU whose frequency may be set in discrete steps or a CPU whose frequency is continuously variable.

It will be noted that power consumption on current processor models is roughly directly proportional to frequency in a linear relationship. Job runtime for a CPU bound job will also typically be roughly directly proportional to frequency. For an I/O bound job, reductions in CPU frequency may have less impact on overall runtime.

The main power consumption within a typical processing node is primarily by the CPU, but other hardware in the node such as fans and power supplies and other support chips and modules can also require a significant amount of power. In cases where the node is not powered down or put into a low power sleep state, then the use of the teachings of the present invention would typically cause the total power consumption to remain roughly the same or slightly increase while retaining the benefit of the peak power consumption being lower during the periods of reduced frequency. In cases where the node could have been powered down or put into a low power sleep state, then total power may actually increase, but the peak power would still typically be reduced by the use of the teachings of the present invention.

It will be further noted out that the peak operating temperatures for each node whose frequency is regulated will also be smoothed. The resulting smoothing of the power consumption and accompanying smoothing of temperature variations could prove beneficial for increasing the lifetime of the components.

A further illustrated embodiment of this present invention utilizes the observation that when a backfill scheduler selects a job or jobs to run in the scheduling voids as previously described, the void will typically not be completely filled. This refinement according to the teachings of the present invention enables the scheduler to determine that the attempt at backfill has left a portion of the void unfilled. This portion can then be eliminated or nearly eliminated by the scheduler reducing the CPU frequency of the node or nodes where the backfill job or jobs are being run. This frequency reduction results in elongating the runtime of the job or jobs, but the adjustment in frequency will be made such that the jobs will still be able to complete in time so as to not impact the overall system schedule. This reduction in frequency results in a reduction in peak power requirements for the site during this period of operation.

Another useful refinement according to the teachings of this invention as shown in a further illustrated embodiment of the present invention is based upon recognizing that after a job or jobs has been deployed at a reduced frequency, a job of higher priority may arrive whose start time may be expedited by having the scheduler reduce elongation of the already launched jobs by increasing their CPU frequency. This increasing of the frequencies of jobs already in execution in turn may produce a void suitable for the running of the newly arrived job or jobs.

It will be noted that the prediction of the runtime of a job may not be precise whether its time is estimated by a person running the job, based upon history, or calculated using some algorithm. Therefore, another refinement according to the teachings of this invention as shown in a further illustrated embodiment is based upon recognizing if a job with previously reduced frequency is running longer than its expected or forecasted time and is now delaying the start of another job, in which case the frequency reduction can be canceled and the frequency increased by the scheduler.

### BRIEF DESCRIPTION OF THE SEVERAL VIEWS OF THE DRAWINGS

The invention is better understood by reading the detailed description of the invention in conjunction with the accompanying drawings in which:

FIG. 1 illustrates a table depicting an exemplary set of programs (jobs) to be run labeled “Job Set #1” with its predicted resource requirements, an exemplary execution timeline for that job set as might be observed using a typical prior art FIFO scheduler, and a second exemplary timeline for that same job based on using a typical FIFO scheduler and also a normal backfill scheduler;

FIG. 2 illustrates a further table depicting a second exemplary job set labeled “Job Set #2” with its predicted resource requirements, an exemplary execution timeline for that job set as might be observed using a typical prior art FIFO scheduler, and a second exemplary timeline for that same job based on using a typical prior art FIFO scheduler and also a normal prior art backfill scheduler;

FIG. 3 illustrates a third exemplary timeline for Job Set #2 as might be observed utilizing a scheduler which operates to reduce peak power requirements by reducing the processing frequency for selected hardware servicing selected jobs;

FIG. 4 illustrates a fourth exemplary timeline for Job Set #2 according to an illustrated embodiment of the present invention in which a normal FIFO scheduler is combined with an enhanced backfill scheduler according to the teachings of the present invention which reduces frequency of processing for certain nodes, those nodes specifically selected for frequency reduction by the backfill scheduler;

FIG. 5 illustrates a fifth exemplary timeline for Job Set #2 as might be observed during the operation of a further illustrated embodiment of the present invention in which a normal FIFO scheduler is utilized and then combined with a further enhanced backfill scheduler according to the teachings of the present invention which reduces frequency of processing for certain nodes, those nodes specifically selected for frequency reduction by the backfill scheduler, and further allowing for jobs to be reduced in frequency over periods of time for purpose of reducing peak power while still completing the job set within a determined deadline, optionally based upon the original FIFO schedule completion deadline; and,

FIG. 6 illustrates exemplary processing steps performed by an enhanced backfill scheduler in an illustrated embodiment of the present invention.

### DETAILED DESCRIPTION OF THE INVENTION

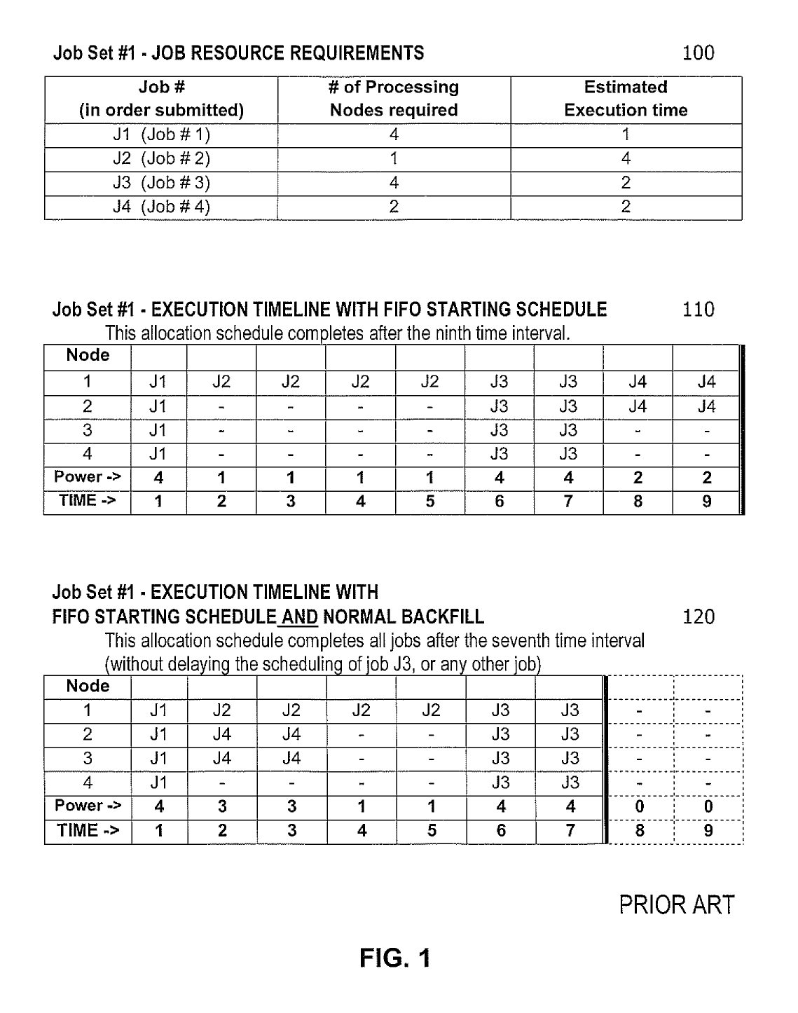

FIG. 1 is a table 100 that illustrates a set of four programs to be scheduled for running on a computer system such as a High Performance Cluster computer system. While the low number of programs such as four is not typical in that typically there might be dozens, hundreds or even more jobs running simultaneously on a large system, but four jobs is enough to illustrate the one particular method of scheduling jobs described herein. The Job Resource Requirements for the four jobs are depicted in table 100, that corresponds to the four jobs designated as J1, J2, J3, and J4. As indicated, Job 1 requires four “nodes” and is estimated to require one unit of execution time; Job 2 requires one node for four units of time, and so on as depicted in the table 100. As used herein, a “node” is an arbitrary name for one or more processing units, typically connected closely and/or physically together. The “unit” of execution time is arbitrary and could be any unit of time useful at a level for illustrating a division of jobs into manageable units of time, such as milliseconds or seconds for example.

FIG. 1 also depicts a timeline 110 which illustrates a scheduling for running the jobs in Job Set #1, to their expected completion, over a period of nine time units. The scheduler utilized is a First In First Out Scheduler which for example might schedule jobs numbered one to four in the order “1” to “4”, with “J1” being scheduled first, and allocated four nodes for one time unit, which is depicted in time slot “1” in the table 100. “J2” require only one node and is estimated to take four units of time, and is therefore give node one for time slots two through five. “J1” is predicted to be over by the end of time slot “1”, so node “1” is available for “J2” to begin at the beginning of time slot “2”. In similar manner as shown “J3” takes four nodes for two time slots, and “J4” takes two nodes for two time slots, with all four jobs estimated to be complete by the end of time slot “9”.

This description provided in FIG. 1 table 110 does not necessarily illustrate having accomplished getting the four jobs completed as quickly as possible, given the resources, in that it can be observed in table 110 that some of the nodes are not used in time slots “2” through “5”. An enhancement to typical FIFO scheduling which is called “backfill” scheduling provides for job “J4” to be merged “back” into allocation during time slots “2” and “3”, since nodes “2” and “3” are unused during those time periods. This allows for job J4 to be completed earlier, in parallel with the processing of job “J2” and thus all four jobs can be estimated to be completed by the end of time slot “7”.

Further depicted in FIG. 1, is a table 120 that provides an estimate of “power” (such as watts) utilized during each unit of time, with the assumption that processing one job on one node takes one unit of power. This assumption would not be necessarily accurate, but is adequate for illustrating approximate units of power expended by the four jobs.

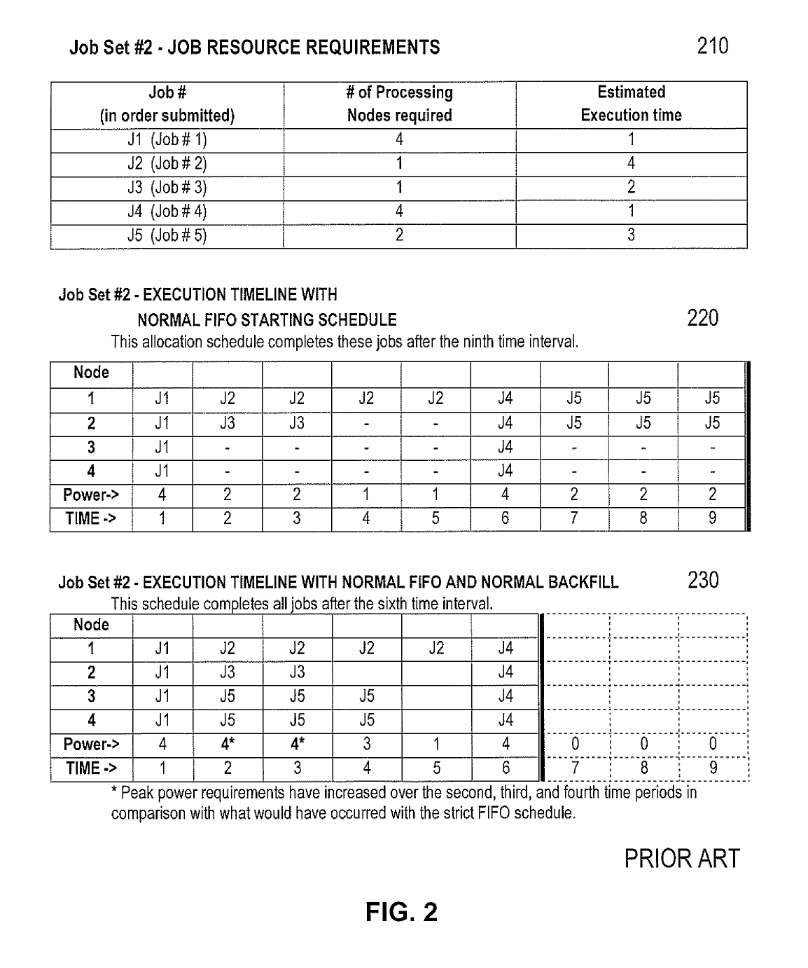

FIG. 2 provides illustration of a table 220 containing a second job set called “Job Set #2” comprising a set of five jobs with Job Resource Requirements shown in the table 220 describing for each of the five jobs the number of nodes required and an estimated execution time. As in the case of FIG. 1, FIG. 2 table 220 illustrates an Execution Timeline with a Normal FIFO Starting Schedule. Jobs “J1” through “J5” are scheduled in starting order from “1” to “5”. It will be noted that for this example, the “FIFO” scheduling of job “J5” starts job J5 in time slice “7” because J4 is already scheduled in time slice 6, and no other nodes available for running “J5” in parallel or starting after the start of “J4”. It will be noted however that during time slices “1” to “3” and “6”, the total power for the four nodes is four, that is, all four nodes are running a job at high frequency.

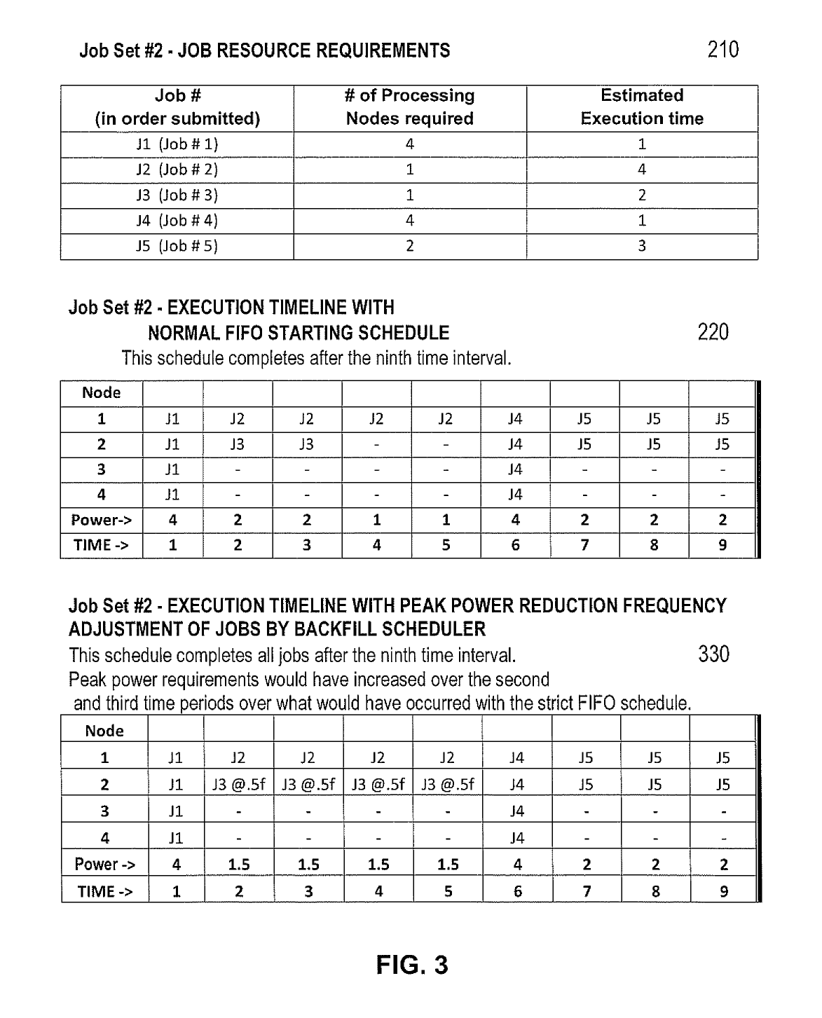

According to a further illustrated embodiment of the present invention depicted in the FIG. 3 that is based on the recognition that when a FIFO scheduler selects a job or jobs to run, it is likely that there are time units during which all nodes are not utilized, and therefore the scheduler can include a capability of spreading selected jobs over a larger than normal number of time units, by reducing the frequency (and/or voltage). As shown in timeline 220, job “J3” is processed only during time periods “2” and “3”. The FIFO scheduler includes the capability of recognizing during job scheduling however that there are “holes” during time periods “4” and “5” for nodes “2”, “3”, and “4”. Thus, the scheduler can provide for processing Job “J3” with control parameters such that the assigned nodes consume less power, but the job as a consequence will be expected to take longer. In the depicted time line 330 in FIG. 3, job “J3” is run at ½ frequency for four time units instead of two. That is, job “J3” runs at ½ speed during time slices “2” to “5” (four time units) instead of in two time units, “2” and “3” from the FIFO schedule shown in table 220 (depicted above in the same FIG. 3). As a direct consequence of such operation, the power consumed during time periods “2” to “5” is reduced to “1.5” units evenly spread over time units “2” to “5”.

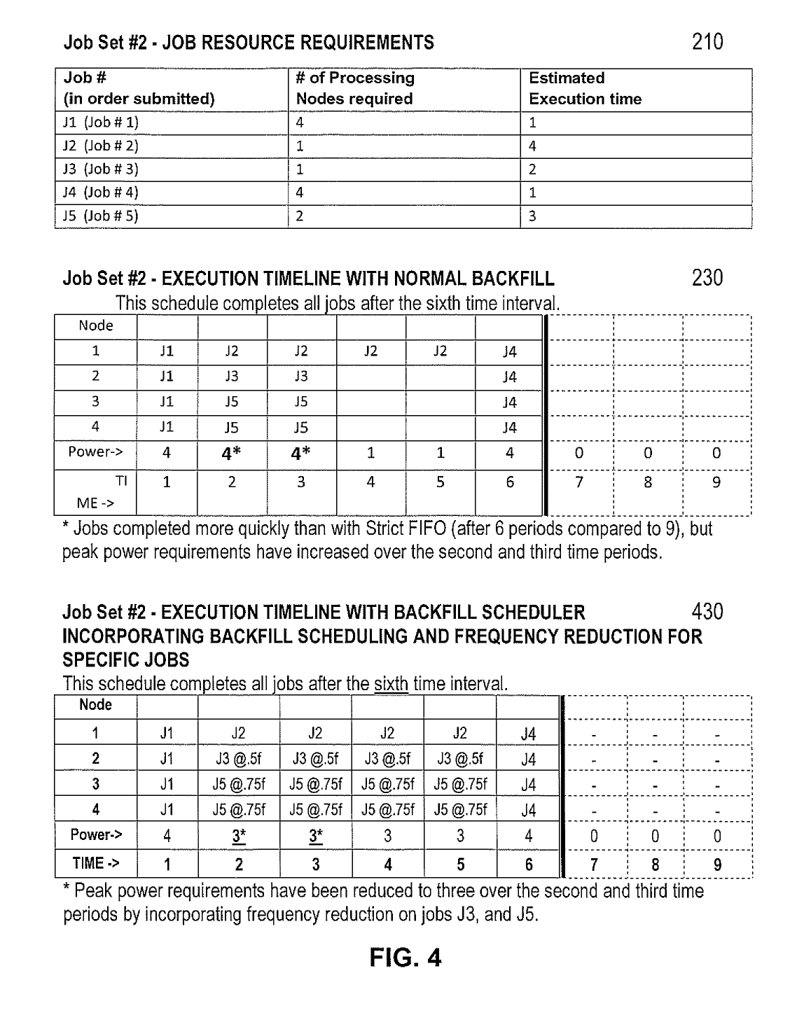

According to another illustrated embodiment of the present invention illustrated in FIG. 4, it can be seen that combining power reduction management for selected nodes with a backfill scheduler (previously described) enables power usage to be spread even more evenly while at the same time still reducing the time required for processing all five jobs. In FIG. 4, timeline 230 depicts a schedule utilizing a backfill scheduler with power usage of “4” in time slices “2” and “3”. According to the teachings of the present invention, an enhanced backfill scheduler can accomplish the same total work in the same six time units with a schedule as shown in the timeline 430 of FIG. 4 in which jobs “J3” and “J5” are both run at half frequency and take twice as long. This enables the enhanced scheduler to spread the power usage evenly at a power of “3” over time units “2” to “5”. This is in comparison to the use of the non-enhanced backfill method for which power is depicted at “4” in time slices “2” and “3” and power of “1” during time slices “4” and “5”. The enhancement of adding power management on a node basis to the operational steps of the backfill scheduler provides for power consumption to be made steadier, or more even over time.

It will be noted however in the timeline 330 of FIG. 3 and the timeline 430 of FIG. 4 that high peak power usage of “4” still occurs during time slices “1” and “6”. With the first enhanced backfill scheduler or with normal backfill scheduling, it has been assumed that getting jobs completed as quickly as possible is a typical benefit. However, for a system or cluster for which peak power leveling is important, it is an advantage according to the teachings of the present invention to provide a further enhancement to the backfill scheduler that takes into account that if jobs “J1” to “J5” can be scheduled for completion over nine time periods or units, the original time taken by a normal FIFO scheduler, then the power management for a plurality of jobs and maybe even if all of the jobs are set so as to reduce power consumption and power consumption is spread somewhat evenly over nine time units, instead of the faster six time units.

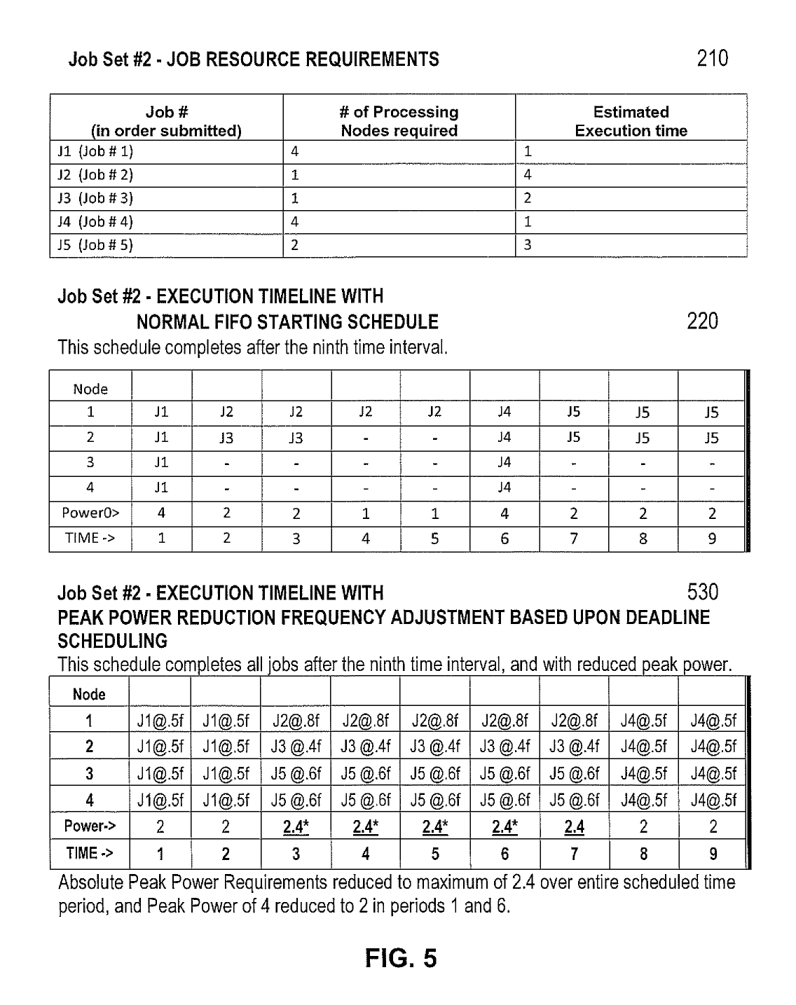

In FIG. 5, an exemplary scheduling example diagrammatically illustrates reducing the frequency of all of the nodes to selected percentages of a maximum frequency so as to achieve a maximum peak power of 2.4 units during time periods “3” to “7” and a peak power of 2.0 units for the remaining time periods. Comparing timeline 530 with timeline 220 in FIG. 5 on the same page shows a notable smoothing of power usage over the nine time units.

Decisions to take longer to run particular jobs at a reduced speed; e.g., J5, as opposed to running them at their fastest time, can be based on other scheduler criteria such as user attributes, user specified job submission parameters, time of day, temperature of rack, current site peak power usage, and other factors which will be obvious to those knowledgeable in the art. The method and enhanced scheduler operation according to the present invention utilizes the techniques of the backfill scheduler to locate candidate jobs that provide for reduced power consumption.

In other illustrated embodiments, the method of the present invention can be employed to utilize the site scheduler so as to control the processor speed for each job step in order to get more predictable results.

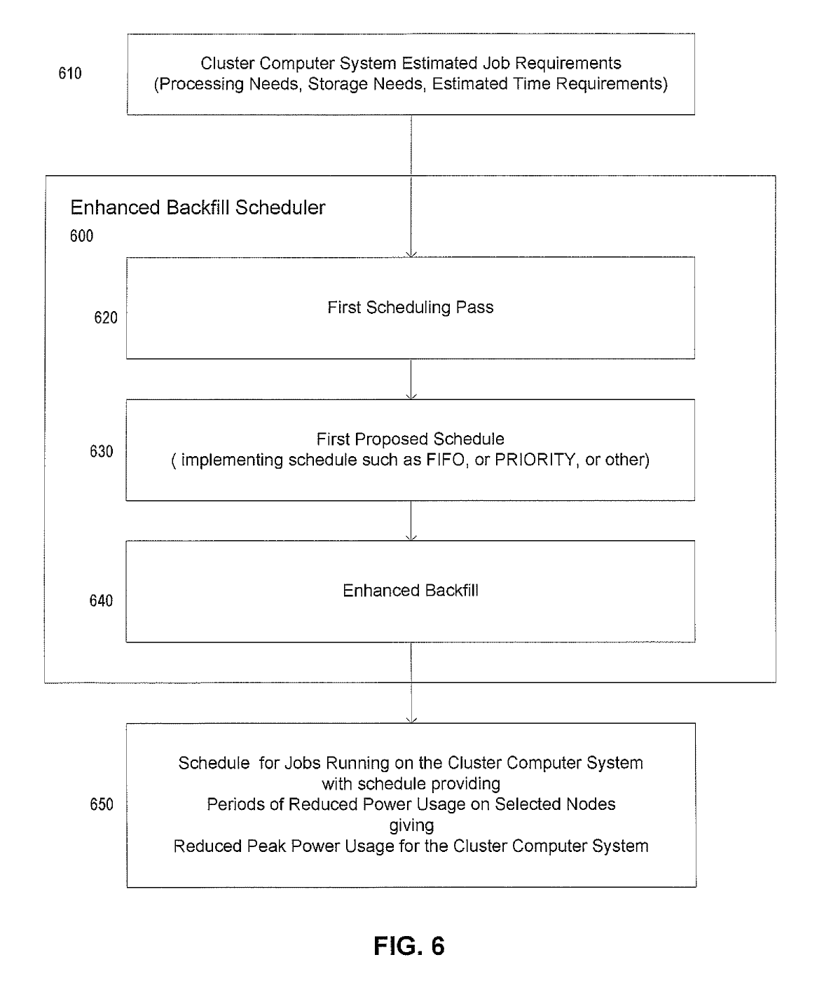

FIG. 6 illustrates the exemplary processing steps performed by an enhanced backfill scheduler according to a further illustrated embodiment of the present invention. In FIG. 6, a set of estimated job requirements 610 is provided to an enhanced backfill scheduler 600 of a cluster computer system. The enhanced backfill scheduler performs processing steps typically based on control programs which are loaded into memory of a computer system on which the scheduler program or module is running. The scheduler is typically implemented as part of the Operating System but can also be implemented as an application program. The steps performed by the enhanced backfill scheduler 600 are labeled or designated as steps 620, 630, and 640 in FIG. 6, but these steps could be combined or performed in other manner as could be readily understood or appreciated by one skilled in the art of programming computer system schedulers. The first exemplary step 620 of the enhanced backfill scheduler is performed to develop a first proposed schedule which assigns proposed time slots for jobs executing on selected nodes. This step would typically be implemented using standard techniques. The first proposed schedule is then stored in computer system memory, and this schedule is then analyzed by an enhanced backfill procedure or method 640 which may itself include multiple steps. For example, the first schedule may be analyzed and jobs moved to fill in unused time slots in the proposed schedule. The modified schedule is then analyzed as to predicted or computed power usage, and where a need to conserve power usage is identified, nodes are identified which should be run at reduced frequency during selected periods of time so as to reduce overall Cluster Peak Power usage. The modified schedule would typically attempt to have the scheduler 600 schedule jobs to be completed within certain time limits, either identified by a user or possibly determined from the first proposed schedule.

The illustrated method and enhanced scheduler of the present invention may be employed in conjunction with the operations described above.

It may provide further benefits in the operation of a High Performance Computer cluster, or any computer system in terms of providing a method which allows for computer system users or administrators to provide input to the scheduling of programs, jobs, or job sets that enables the method being employed or performed by the computer system scheduler to utilize that input in making scheduling decisions. For example, a user could choose to maximize performance during running of a particular job by selecting not to allow power management by the scheduler. (It will be noted that power management by the hardware, BIOS, or operating system still may occur to avoid damaging equipment or for other reasons). In this manner users can “help” or assist the method employed or performed by the scheduler to make better decisions by providing at least some indication and information to the scheduler as to, for example, as to which jobs are most important, which jobs cannot employ processor frequency management, and which jobs must be completed within specific time periods.

In another illustrated embodiment that incorporates the teachings of the present invention, a selection by a user or administrator might provide a user with the capability of allowing power management with potential for increasing run time in return for reduced billing or charges incurred for running a particular program or job. Connecting or associating billing, rates of resource usage accounting, or other “cost” or “charges” for running particular programs or jobs with user input describing desired or allowed power management by the scheduler would provide incentive for users to allow or select to have power management applied to their job(s). In a further enhancement, specific user jobs could be implicitly run and billed with permission given to apply power management based upon the job being run “from” a specific computer system user id (userid) source.

What is claimed is:

1) A method performed by a backfill job scheduler scheduling running of a plurality of jobs on a computer system having multiple nodes, the method providing for reducing peak computer system power usage during running of the plurality of jobs, the computer system providing to the scheduler with the capability of controlling processor frequency of operation for one or more selected nodes of the multiple nodes of the computer system, a reduction in node processor frequency typically resulting in reduced power usage on that node during the period of reduced frequency, the steps of the method comprising:
a) assigning a first possible schedule executable by the scheduler which specifies a first scheduled order for running the plurality of jobs within a first amount of time;
b) modifying the first possible schedule by having the scheduler perform a backfilling operation that produces a second schedule having a second scheduled order for running the plurality of jobs within a scheduled second amount of time, the scheduled second amount of time being less than the first amount of time;
c) the scheduler examining the second schedule and identifying holes occurring in scheduled time allocated in the second schedule during which one or more individual nodes are not being fully utilized, for creating a list of holes wherein each entry for each hole in the list of holes identifies an underutilized node and an underutilized time period during which the node is not being fully utilized;
d) the scheduler further examining or searching the second schedule of step c and identifying those jobs which utilize the underutilized nodes during adjacent time periods in the second schedule, each adjacent time period representing a period of time adjacent in time to each node's associated underutilized periods of time, those jobs being identified or designated as adjacent jobs by the scheduler; and
e) the scheduler modifying frequency control parameters included in the second schedule to reduce the frequency of operation of the nodes which are scheduled to run one or more of the identified adjacent jobs during at least a portion of the adjacent time periods to move processing time of those identified adjacent jobs into the holes in the scheduled time in the second schedule, and to reduce power usage on the node during the adjacent time periods.

2) A method performable by a job scheduler of a computer system with multiple nodes, for reducing peak computer system power usage while running a plurality of jobs, the scheduler including within its control parameters a capability of controlling frequency of operation of selected nodes of the multiple nodes of the computer system, the steps of the method comprising:
a) the scheduler first assigning a first possible schedule for running that plurality of jobs;
b) the scheduler next identifying holes in time in the first possible schedule, the holes being one or more periods of time during which one or more specific nodes of the computer system are not being fully utilized;
c) the scheduler then identifying one or more adjacent jobs assigned in the first possible schedule to utilize those same one or more specific nodes during periods of time adjacent to the holes in the periods of time in the first possible schedule; and
d) the scheduler modifying frequency control parameters included in the first possible schedule so as to reduce the frequency of operation of the nodes which are scheduled to run the one or more of the identified adjacent jobs during at least a portion of the period of time adjacent to the holes in the periods of time to move processing time of those adjacent jobs on their assigned nodes into the holes in the periods of time.

3) A method for potentially reducing peak power usage on a computer system comprising the steps of:
a) providing to one or more users of the computer system an option facility or mechanism within the computer system for specifying permission to apply specific power management techniques during processing of one or more selected jobs by the computer system; and,
b) generating billing information for the user of the computer system at a reduced rate, compared to a normally applied rate of billing for running jobs, as a consequence of user selection of the option that allows application of the specific power management techniques during processing of the selected jobs by the computer system.

4) A method performable by a backfill job scheduler of a computer system having multiple nodes, for reducing peak computer system power usage while running a plurality of jobs, the scheduler including within control parameters associated therewith, the capability of controlling frequency of operation for selected nodes of the multiple nodes of the computer system, the steps of the method comprising:
a) the scheduler assigning a first possible schedule which specifies a first scheduled order for running that plurality of jobs within in a first amount of time;
b) next, the scheduler modifying that first possible schedule by performing a backfilling operation to produce a second schedule having a second scheduled order for running that plurality of jobs within a second amount of time, the second amount of time being less than the first amount of time;
c) the scheduler then examining the second schedule and identifying holes in scheduled time within the second schedule during which one or more individual nodes are not being fully utilized, for identifying a plurality of underutilized holes, each identified hole in the plurality of holes identifying the underutilized node and the underutilized time period during which the node is not being fully utilized;
d) the scheduler further examining the second schedule and identifying jobs which utilize the underutilized nodes during adjacent time periods, each of the adjacent time periods being a period of time adjacent in time to each node's associated underutilized periods of time in the second schedule, the jobs being identified or designated as adjacent jobs by the scheduler;
e) the scheduler modifying frequency control parameters in the second schedule so as to reduce the frequency of operation of the nodes which are scheduled to run one or more of the identified adjacent jobs during at least a portion of the adjacent time periods so as to move processing time of those identified adjacent jobs into the holes in scheduled time in the second schedule; and,
f) the scheduler again examining and then modifying the second schedule so as to reduce peak power usage by reducing frequency of operation of one or more nodes during the first time period while still maintaining expected completion of the plurality of jobs within the first time period.

5) An enhanced backfill scheduler for use in a cluster computer system having multiple nodes, the enhanced scheduler enabling reduction of peak computer system power while running a plurality of jobs over a period of time, the computer system providing within control parameters used by the scheduler a capability of controlling frequency of operation for selected nodes of the multiple nodes of the computer system, the enhanced scheduler running on either the cluster computer system itself or on another computer system and the scheduler comprising:
a) a first table storing a first possible schedule assigned by the scheduler for the plurality of jobs on the cluster computer system, the first possible schedule specifying a first scheduled order for running that plurality of jobs in a first amount of time;
b) the scheduler including a backing filling mechanism for modifying the first possible schedule by performing a backfilling operation to generates a second schedule in a second table having a second scheduled order for running that plurality of jobs in a second amount of time, the second amount of time being less than the first amount of time;
c) the scheduler further including a search mechanism for examining the second schedule and identifying holes in scheduled time occurring in the second schedule during which one or more individual nodes are not being fully utilized, for identifying a plurality of holes with each entry for each hole in the list of holes designating the underutilized node and the underutilized time period during which that node is not being fully utilized;
d) the search mechanism being operative to further examine the second schedule and identify jobs which utilize the underutilized nodes during adjacent time periods, each of the adjacent time periods being a period of time adjacent in time in the second schedule to each node's associated underutilized periods of time, the jobs being identified by the search mechanism as adjacent jobs;
e) the scheduler invoking the capability for controlling frequency of operation to modify frequency control parameters included in the second schedule of the second table to reduce the frequency of operation of the nodes which are scheduled to run one or more of the identified adjacent jobs during at least a portion of the adjacent time periods to move processing time of those identified adjacent jobs into the holes in the scheduled time of the second schedule; and
f) the search mechanism further operating to reexamine and then modify the second schedule of the second table to reduce peak power usage by reducing the frequency of operation of one or more nodes during determined periods of time specified in the second table while still completing the plurality of jobs within the first time period.
